(19) United States
(12) Patent Application Publication
(10) Pub. No.: US 2026/0081848 A1
(43) Pub. Date: Mar. 19, 2026

(54) GENERATING SYMBOLS USING NEURAL NETWORKS IN A WIRELESS COMMUNICATIONS SYSTEM

(71) Applicant: Lenovo (United States) Inc., Morrisville, NC (US)

(72) Inventor: Vahid POURAHMADI, München (DE)

(21) Appl. No.: 19/402,113

(22) Filed: Nov. 26, 2025

(51) Int. Cl. H04L 41/16; G06N 3/08; H04L 5/00

(52) U.S. Cl. CPC H04L 41/16; G06N 3/08; H04L 5/0005

(57) ABSTRACT

Various aspects of the present disclosure relate to neural network (NN)-based techniques that support the association of one data bit (e.g., input bit) to multiple resource elements (REs) via NN-based mapping blocks (or NN-based symbol generators) within a transmission chain of a transmitting node. For example, the transmission chain may insert the NN-based mapping block between a layer mapping block and precoding block, enabling the NN-based mapping block to generate output symbols from a sequence of modulation symbols. The NN-based mapping block, therefore, may operate to generate some or all RE symbols for each spatial layer, enabling adaptive symbol generation while maintaining compatibility within a transmission chain.

### TECHNICAL FIELD

The present disclosure relates to wireless communications, and more specifically to generating symbols using neural networks (NNs) and/or deep learning models.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that provide and/or support generating symbols using NNs and/or deep learning models.

A network node for wireless communication is described. The network node may be configured to, capable of, or operable to perform one or more operations as described herein. For example, the network node may comprise at least one memory and at least one processor coupled with the at least one memory and configured to cause the network node to receive a set of input bits, generate a first sequence of modulation symbols based on the set of input bits, generate a second sequence of output symbols by processing a portion of the first sequence of modulation symbols with an NN-based symbol generator, generate a third sequence of transmission symbols from the second sequence of output symbols, wherein a number of transmission symbols equals a number of allocated resource elements (REs) for the network node, map the third sequence of transmission symbols to the allocated REs in a time-frequency grid, and transmit the mapped third sequence of transmission symbols on the allocated REs to a receiving node.

A method performed or performable by the network node is described. The method may comprise receiving a set of input bits, generating a first sequence of modulation symbols based on the set of input bits, generate a second sequence of output symbols by processing a portion of the first sequence of modulation symbols with an NN-based symbol generator, generating a third sequence of transmission symbols from the second sequence of output symbols, wherein a number of transmission symbols equals a number of allocated REs for the network node, mapping the third sequence of transmission symbols to the allocated REs in a time-frequency grid, and transmitting the mapped third sequence of transmission symbols on the allocated REs to a receiving node.

In some implementations of the network node and method described herein, at least one symbol of the second sequence of output symbols is based on at least two bits of the set of input bits that are modulated in distinct symbols of the first sequence of modulation symbols.

In some implementations of the network node and method described herein, a part of the third sequence of transmission symbols is further based on modulation symbols of the first sequence of modulation symbols not processed by the NN-based symbol generator.

In some implementations of the network node and method described herein, the network node and method may further be configured to, capable of, performed, performable, or operable to nullify or insert reference signals or other symbols at predetermined RE positions from the allocated REs when mapping the third sequence of transmission symbols to the allocated REs in the time-frequency grid, and wherein the number of transmission symbols equals the number of allocated REs minus a number of the REs that are nullified or filled with reference signals or other symbols.

In some implementations of the network node and method described herein, one or more input bits of the set of input bits are associated with two or more distinct output symbols of the second sequence of output symbols.

In some implementations of the network node and method described herein, a number of modulation symbols of the first sequence of modulation symbols is less than the number of allocated REs for the network node.

In some implementations of the network node and method described herein, the network node and method may further be configured to, capable of, performed, performable, or operable to generate the second sequence of output symbols by inputting additional inputs associated with transmission conditions or parameters to the NN-based symbol generator.

In some implementations of the network node and method described herein, the additional inputs include a channel quality indicator, a signal-to-noise value, a precoding matrix identifier, a rank indicator, or an environment type classification.

In some implementations of the network node and method described herein, the second sequence of output symbols includes at least output symbols that is not based on the set of input bits.

In some implementations of the network node and method described herein, a number of output symbols of the second sequence of output symbols is less than the number of allocated REs for the network node, and wherein the at least one processor is configured to cause the network node to generate the third sequence of transmission symbols by combining output symbols with one or more modulation symbols to fill all of the allocated REs.

In some implementations of the network node and method described herein, the network node and method may further be configured to, capable of, performed, performable, or operable to train the NN-based symbol generator using a loss function based on: an accuracy of recovering the set of input bits at the receiving node, and a penalty for a transmission power associated with transmitting the mapped third sequence of transmission symbols on the allocated REs being above a threshold transmission power.

In some implementations of the network node and method described herein, the NN-based symbol generator includes multiple NN blocks associated with multiple spatial layers via which the network node transmits the mapped third sequence of transmission symbols, and wherein each NN block processes modulation symbols for a respective spatial layer of the multiple spatial layers.

In some implementations of the network node and method described herein, the network node and method may further be configured to, capable of, performed, performable, or operable to generate the third sequence of transmission symbols from the second sequence of output symbols by embedding reference information into the third sequence with data-carrying symbols.

A network node for wireless communication is described. The network node may be configured to, capable of, or operable to perform one or more operations as described herein. For example, the network node may comprise at least one memory and at least one processor coupled with the at least one memory and configured to cause the network node to receive multiple symbols transmitted on REs from a transmitting node, generate an estimate of a set of input bits by processing the received multiple symbols using an NN-based bit generator, and recover the set of input bits based on the estimate of the set of input bits.

A method performed or performable by the network node is described. The method may comprise receiving multiple symbols transmitted on REs from a transmitting node, generating an estimate of a set of input bits by processing the received multiple symbols using an NN-based bit generator, and recovering the set of input bits based on the estimate of the set of input bits.

In some implementations of the network node and method described herein, the network node and method may further be configured to, capable of, performed, performable, or operable to generate the estimate of the set of input bits by inputting additional inputs associated with reception conditions to the NN-based bit generator.

In some implementations of the network node and method described herein, the addition inputs include an indication of RE positions associated with reference symbols or non-data symbols, channel state information or estimated channel values for the REs, or a channel quality metric associated with the reception conditions.

In some implementations of the network node and method described herein, the estimate of the set of input bits includes a soft decision value or a log-likelihood ratio, and wherein the at least one processor is configured to cause the network node to recover the set of input bits by inputting the soft decision value or the log-likelihood ratio into a forward error correction decoder to reconstruct the set of input bits.

In some implementations of the network node and method described herein, the NN-based bit generator includes: a single NN model configured to jointly process symbols received from multiple spatial layers, or multiple NN models each configured to process symbols received from a single spatial layer of the multiple spatial layers.

### BRIEF DESCRIPTION OF THE DRAWINGS

FIG. 1 illustrates an example of a wireless communications system in accordance with aspects of the present disclosure.

FIG. 2 illustrates a transmission chain in accordance with aspects of the present disclosure.

FIG. 3 illustrates an example operation of an NN block in a transmission chain in accordance with aspects of the present disclosure.

FIGS. 4A-4B illustrate example signal generation blocks in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a transmitting node in accordance with aspects of the present disclosure.

FIG. 9 illustrates a flowchart of a method performed by a receiving node in accordance with aspects of the present disclosure.

### DETAILED DESCRIPTION

The present disclosure relates to methods, apparatuses, and systems that provide, support, implement, and/or introduce the use of NNs and other deep learning techniques to enhance wireless communications, such as by enhancing implementation of orthogonal frequency-division multiplexing (OFDM) for wireless transmissions between network nodes.

A network node may identify (e.g., determine or construct) OFDM symbols by mapping data (e.g., input bits) onto REs, which are the smallest units in a time-frequency grid and may be grouped into resource blocks (RBs) that operate as scheduling units for transmissions. The network node may also utilize multiple input multiple output (MIMO) techniques, where multiple antennas at the network node perform spatial multiplexing by simultaneously transmitting multiple data streams across different or multiple spatial paths.

The network node (e.g., a transmitting node) may generate OFDM symbols by encoding data bits using forward error correction (FEC) and mapping the encoded bits to modulation symbols (e.g., quadrature phase-shift keying (QPSK) and/or quadrature amplitude modulation (QAM)), distributing the modulated symbols to multiple spatial layers, assigning the modulated symbols to specific REs, precoding the modulated symbols (e.g., using a precoding matrix to linearly transform the symbols), mapping the precoded symbols to subcarriers and OFDM symbols, generating time-domain signals, and transmitting the signals over the MIMO channels.

In some cases, the network node may perform the modulation of the data bits using an NN-based model and/or other deep learning models. The NN-based model may learn or determine optimal constellation points for mapping the input bits to complex symbols. However, within current NN-based models, each Q data bit (e.g., input bit) may only affect one symbol on one RE, while all J×Q bits are mapped to J symbols (e.g., carrying information only about the Q data bits). Thus, when the RE is not detected by a network node (e.g., a receiving node), for instance, due to noise, nonlinearity, and/or fading, the information of or associated with the Q bits may be lost. Further NN-based techniques (e.g., directly mapping input bit across multiple RBs to RE symbols) integrate modulation, layer mapping, and precoding into a single model, but suffer from complexity and issues associated with beamforming, channel estimation, and so on.

The present disclosure introduces an NN-based technique that supports the association of one data bit (e.g., input bit) to multiple REs via the addition of or the use of an NN-based mapping block (or NN-based symbol generator) within a transmission chain of a transmitting node. For example, the transmission chain may insert the NN-based mapping block between a layer mapping block and precoding block, enabling the NN-based mapping block to generate output symbols from a sequence of modulation symbols. The NN-based mapping block, therefore, may operate to generate some or all RE symbols for each spatial layer, enabling adaptive symbol generation while maintaining compatibility with conventional precoding and beamforming techniques performed by other blocks of the transmission chain.

Thus, the network node may realize various benefits when using the NN-based symbol generator. The network node may provide a flexible association of data bits to symbols, where each symbol transmitted over an RE is derived from a variable number of input bits, allowing redundancy and cross-RE dependency that improves a resilience to channel impairments (e.g., fading or noise) and/or reducing use of dedicated REs for reference signal transmission, improving spectral efficiency for a network. Further, the NN-based symbol generator may incorporate other inputs (e.g., channel quality metrics, transmission ranks, environmental identifiers), which may facilitate the dynamic adaption of wireless communications to current or expected channel conditions, among other benefits.

Aspects of the present disclosure are described in the context of a wireless communications system.

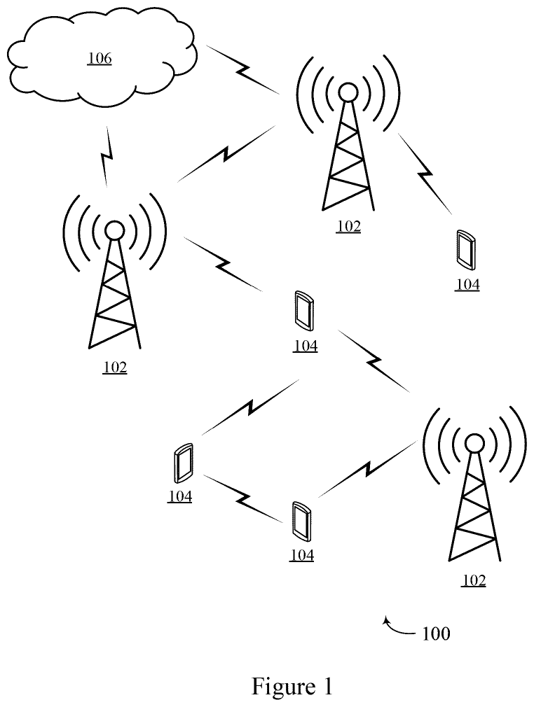

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 or FR2-1 (24.25 GHz-52.6 GHz), FR3 (7.125 GHz-24.25 GHz), FR4 (52.6 GHz-114.25 GHz), FR4a or FR4-1 or FR2-2 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the wireless communications system 100 may introduce and/or implement an NN-based mapping block (or NN-based symbol generator) within a transmission chain of a transmitting node, which may facilitate the association of one data bit (e.g., input bit) to multiple REs when generating output symbols for transmission.

For example, the UE 104, operating as a Tx node, may receive a set of input bits (e.g., data bits), generate a first sequence of modulation symbols based on the set of input bits, generate a second sequence of output symbols by processing a portion of the first sequence of modulation symbols with an NN-based symbol generator, generate a third sequence of transmission symbols from the second sequence of output symbols, and map the third sequence of transmission symbols to the allocated REs in a time-frequency grid. The UE 104 may transmit the mapped third sequence of transmission symbols on the allocated REs to the NE 102, operating as an Rx node.

The NE 102 may receive multiple symbols transmitted on the REs (e.g., the mapped third sequence of transmission symbols), generate an estimate of the set of input bits by processing the received multiple symbols using an NN-based bit generator, and recover the set of input bits based on the estimate of the set of input bits.

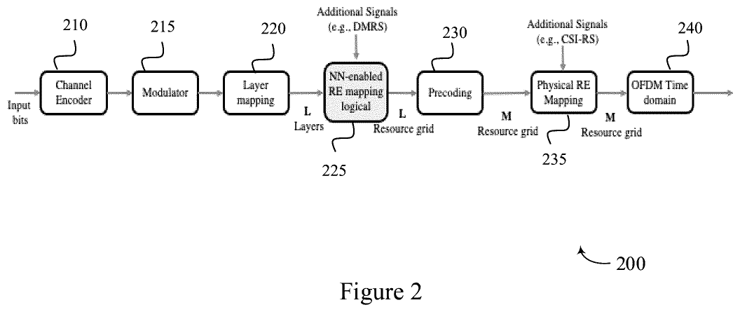

FIG. 2 illustrates a transmission chain 200 in accordance with aspects of the present disclosure. As described herein, the transmission chain 200 may be part of a network node, such as the NE 102 and/or the UE 104, operating as a transmitting node (e.g., Tx node) that performs data transmissions to receiving nodes (e.g., Rx nodes), which may also be the NE 102 and/or the UE 104.

The transmission chain 200 receives input bits (e.g., data bits) by a channel encoder 210, which encodes the input bits. A modulator 215 (e.g., a 16-QAM modulator) modulates the encoded bits. A layer mapping block 220 receives the modulated bits and maps the modulated bits to multiple spatial layers (e.g., L layers). In some cases, the input of the modulator 215 may be input bits that are directly received by the modulator 215 (e.g., do not pass through the channel encoder 210).

When the size of a logical resource grid is L matrices that correspond to L layers, where each matrix represents J subcarriers and S OFDM symbols, there are J×S REs for each layer. Among these REs, for layer l, we assume Jₗ of the REs carry symbols associated with χₗ input bits, where Jₗ and χₗ is based on how the encoded input data is modulated. For example, when all encoded bits for layers l are modulated with a modulation of order Q, then

$${J}_{l} = \frac{{χ}_{l}}{Q} .$$

Within the transmission chain 200, each of the encoded bits is related to one of the REs of the logical resource grid, and the Tx node (e.g., the UE 104) may use all Jₗ REs of the logical resource grid to transmit all χₗ input bits. In some cases, some of the other REs of a logical resource grid may be filled with some other symbols generated (e.g., DMRS) from data other than encoded input data. Thus, the Tx node may not decide to transmit other data (e.g., data in place of pilot symbol RSs) on those REs.

The transmission chain 200, in some examples, inserts or adds an NN-based RE-mapping block 225 (or logical structure). The NN-based RE-mapping block 225 receives the modulated bits (e.g., the data along the L layers), and maps the bits, along with additional signals, such as demodulation reference signals (DMRSs), to REs of a resource grid. In some cases, some of the REs may be empty and/or may be filled with symbols later down the transmission chain 200.

The mapped resource grid is passed to a precoder 230, which constructs M resource grids, where each constructed resource grid corresponds to an antenna port of the Tx node. A physical RE mapping block 235 combines the constructed resource grids, optionally with additional symbols (e.g., channel state information-RS (CSI-RS) signals). An OFDM time domain module 240 transmits the resource grids from each antenna over the air to one or more Rx nodes. Thus, the insertion of the NN-based RE-mapping block 225 into the transmission chain 200 maintains the use of various transmission techniques (e.g., beamforming) while enhancing the generation of output symbols from modulated input bits, among other benefits.

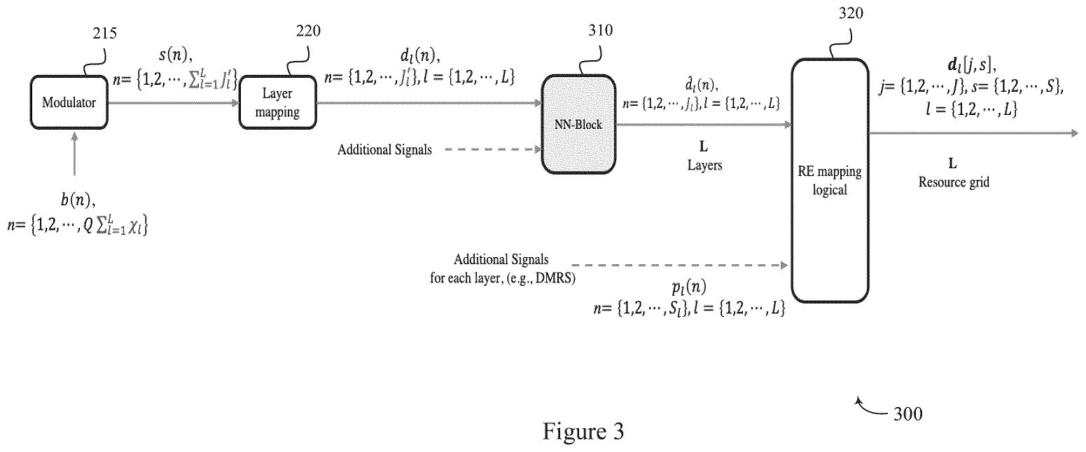

FIG. 3 illustrates an example operation 300 of an NN block in a transmission chain in accordance with aspects of the present disclosure. As described herein, an NN block 310 fills Jₗ REs of the logical resource grid for the layer l based on the encoded input bits. To maintain the same spectral efficiency, the number of encoded bits to be transmitted using the Jₗ REs may be qual to χₗ.

In a transmission chain without the NN block 225, a modulated signal, s(n), has a length equal to the length of the RE to be filled for all layers,

$${\sum }_{l = 1}^{L} {J}_{l}$$

where after layer mapping (e.g., via the layer mapping block 220), becomes Jₗ per layer, where Jₗ is the number of REs in the resource grid associated with the layer l to be filled using the encoded data. However, in using the NN block 225, the output of the NN block 225 may have Jₗ symbols for each layer l, but the number of modulated symbols for each layer (e.g., the input of the NN block 225) may be different than Jₗ

$$( e . g . , {J}_{l}^{′} ) ,$$

with the total or all layers equal to

$${\sum }_{l = 1}^{L} {J}_{l}^{′} .$$

In some cases, the NN block 310 represents at least one example implementation of the NN block 225. The NN block 310 receives at least a part, portion, or subset of the

$${J}_{l}^{′}$$

generated symbols for each layer and generates all Jₗ symbols or at least some of the Jₗ symbols for each layer. When the NN block 310 does not generate all Jₗ symbols, the remaining symbols may also be generated in other ways and/or be concatenated to generate a final set of samples with a length of Jₗ symbols. An RE mapping block 320 may perform the mapping of layers with additional signals (e.g., DMRS signals), and output a resource grid, as described herein.

In some cases, the NN blocks for different layers are the same, where data passes through the same NN blocks (e.g., the NN block 310) during training modes. In some cases, the structure of the NN blocks (e.g., for different layers) are the same, but their weights are different. For example, during a training phase there will L NN blocks (with the same structure) and data of each layer passes through its respective NN blocks and each NN block learns a different mapping scheme.

In some cases, such as when

$${J}_{l}^{′}$$

is smaller than Jₗ, the NN block 310 generates at least

$${J}_{l} - {J}_{l}^{′}$$

symbols. For example, the output of the NN block 310 may be all Jₗ samples or at least a part of all of the

$${J}_{l} - {J}_{l}^{′}$$

symbols. The RE mapping block 320 may then construct the Jₗ symbols from the output of the NN block 310 and the original

$${J}_{l}^{′}$$

symbols. For example, the NN block 310 generates

$${J}_{l} - {J}_{l}^{′}$$

symbols, and the final output is a concatenation of the input

$${J}_{l}^{′}$$

symbols and the generated

$${J}_{l} - {J}_{l}^{′}$$

symbols.

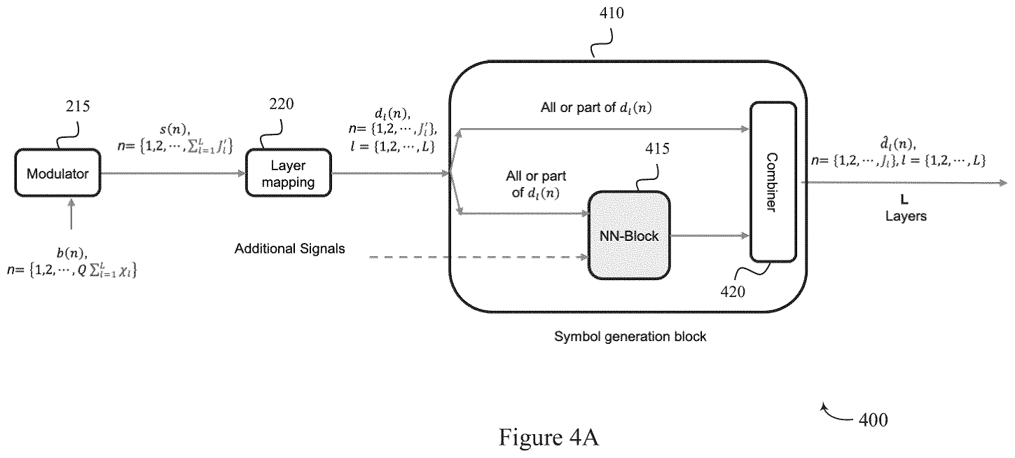

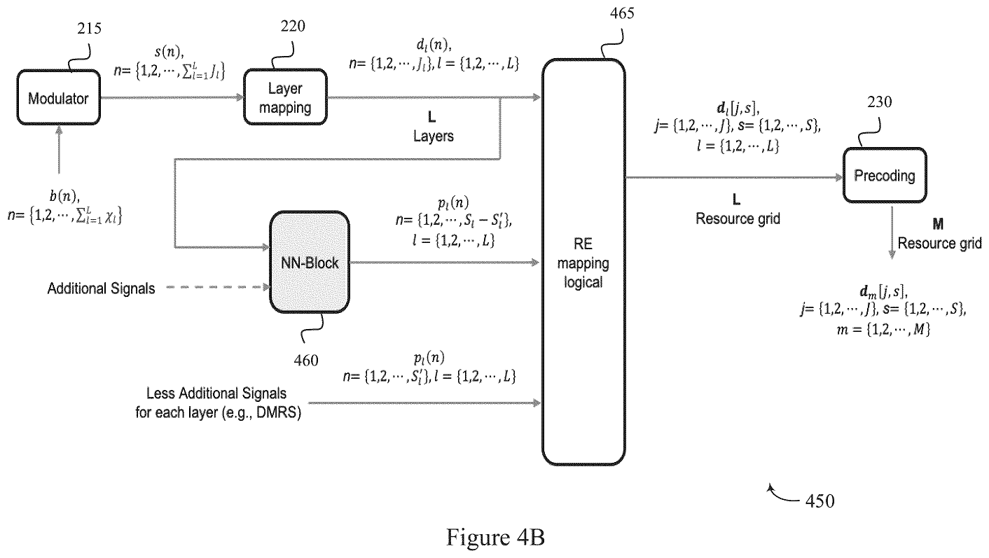

FIGS. 4A-4B illustrate example signal generation blocks in accordance with aspects of the present disclosure. For example, a transmission chain 400 of FIG. 4A implements a symbol generation block 410, which includes an NN block 415 (e.g., the NN block 310) and a combiner block 420 that concatenates the output of the NN block 415 and the

$${J}_{l}^{′}$$

symbols of the output of the layer mapping block 220.

In some cases, the modulator 215 may utilize a modulation order that is higher than

$$\frac{{χ}_{l}}{{J}_{l}} ,$$

resulting in

$${J}_{l}^{′}$$

being less than Jₗ. In some cases, the NN block 415 may receive as input other symbols or conditions, such as fixed values, valued based on a channel state (e.g., a signal-to-noise ratio (SNR), a precoding matrix indicator (PMI) of a previous transmission, and so on), an identifier associated with channel statistics (e.g., urban environment, indoor environment), a rank of a transmitted signal, and so on.

In some cases, such as with respect to a conventional transmission chain, the Tx node may determine to reserve fewer REs

$${S}_{l}^{′} < {S}_{l}$$

(optionally zero REs) for transmission of other symbols (e.g., DMRS). Such a determination may increase the number of REs available to carry data information (e.g., a larger Jₗ). In such cases, the NN block 415 determines a mapping such that an Rx node can estimate the transmitted bits without using additional information (e.g., using a DMRS). Such estimation may lead to lower overhead and/or higher spectral efficiency since the REs are used for transmission of the encoded data. During pilot-less transmission, no REs are to be used for transmission of DMRS symbols.

In cases of fewer reserved REs

$$( e . g . , {S}_{l}^{′} < {S}_{l} ) ,$$

the NN block 415 may only generate the signal to be transmitted on the newly free or available REs. Thus, the NN block 415 generates the remaining

$${S}_{l} - {S}_{l}^{′}$$

symbols (e.g., a new type of pilots that may only be repetitions of the original symbols). FIG. 4B depicts such a scenario 450, where an RE mapping block 465 receives, as input, the layers from the layer mapping block 220, output symbols from an NN block 460, and/or additional signals for each layer. The NN block 460 generates

$${S}_{l} - {S}_{l}^{′}$$

symbols based on at least some parts of the layer mapping block 220 and potentially additional signals, such as fixed values, valued based on a channel state (e.g., an SNR, a PMI of a previous transmission, and so on), an identifier associated with channel statistics (e.g., urban environment, indoor environment, and so on), a rank of a transmitted signal, and so on.

Thus, in some examples, the transmission chain 200, implemented by a Tx node (e.g., the NE and/or the UE 104) may include blocks or logic configured or implemented to receive a set of input bits, generate a first sequence of modulation symbols based on the set of input bits, generate a second sequence of output symbols by processing a portion of the first sequence of modulation symbols with an NN-based symbol generator or block, generate a third sequence of transmission symbols from the second sequence of output symbols (e.g., where the number of transmission symbols equals a number of allocated REs), map the third sequence of transmission symbols to the allocated REs in a time-frequency grid, and transmit the mapped third sequence of transmission symbols on the allocated REs to an Rx node (e.g., the NE 102 and/or another UE 104)

In some examples, the modulator 215 may receive the input bits, without any encoding performed by the channel encoder 210. Because the input bits are generally shorter (e.g., extra bits are not added by the channel encoder 210) the modulator 215 may employ a lower order modulation to achieve a desired number of modulated symbols. Similarly, if the modulator 215 uses the same modulation order, there is a smaller

$${J}_{l}^{′}$$

per layer and a higher ratio of parity/supporting/extra REs

$$( e . g . , \frac{{J}_{l} - {J}_{l}^{′}}{{J}_{l}^{′}} )$$

for transmission. Thus, the NN blocks 310, 415 may perform and or implement the channel encoding during the modulation and/or mapping of the REs.

The design of the NN blocks 310, 415 may be based on the input bits and/or output symbols being complex numbers or values. For example, each complex value input may be represented by two numbers, for the real and imaginary parts, and input as separate real-valued neurons. Similarly, the NN blocks 310, 415 may generate by output signals by combining the output of the two real-valued neurons.

In some examples, the receiving node (e.g., a receiver) may perform various techniques to recover transmitted data. For example, the receiver may generate a sequence of logic-likelihood ratio (LLR) values, zₗ(n), corresponding to a segment of b(n) that is mapped to a layer l. A channel decoder receives the sequence for determination of the transmitted data.

The Rx node, or receiver, may utilize or implement an NN block or perform NN-based determinations, as described herein. For example, an NN-based Rx node may receive a signal at least on REs used for transmission of dₗ(n) for each layer. The NN-based Rx node may receive the location of the REs used for transmission of additional symbols and/or the sequence used for the generation of DMRS symbols.

Thus, in various examples, the Rx node (e.g., the NE 102 and/or the UE 104) may receive multiple symbols transmitted on REs from a Tx node (e.g., the NE 102 and/or the UE 104), generate an estimate of a set of input bits by processing the received multiple symbols using an NN-based bit generator or block, and recover the set of input bits based on the estimate of the set of input bits.

In some cases, the NN-based Rx node may perform channel estimation for each layer and utilize the estimated channel values as additional inputs and/or other information (e.g., channel SNR, PMI, and so on). The Rx node may implement different NN-based models for detection of different layers or utilize a single NN-based model that generates an estimation for all spatial layers.

In some cases, the NN-based models deployed at the Tx node and the Rx node are trained together. For example, the NN-based models are trained for one RB, and the NN-based models can be used in parallel for each RB (e.g., where an actual network supports a bandwidth and/or number of OFDM symbols larger than one RB).

In some examples, the Rx node may utilize symbol-level rate-matching used when the number of available REs for data transmission in an RB may be more or less than the J REs for the Tx node (e.g., due to a different number of OFDM symbols). For example, when the number of available REs for data transmission in an RB is more than the number of J REs, the symbols on some of the REs may be repeated to match the number of available REs for data transmission (e.g., using circular symbol buffer rate matching).

In some examples, to determine the values/parameters for the NN-based model, the NN-based model is trained as follows. First, the Tx node is fed via batches of B samples, where each sample is composed of randomly generated b(n), the data for all layers. Based on the input, the Tx node generates the OFDM symbols based on the current weights of its NN block (e.g., NN block 310). The NN block may receive information regarding the channel SNR, the PMI (or a version of PMI) related to the channel that the signal will experience. The channel information may be fixed and/or different for all samples of each batch.

A channel model receives the symbols and simulates the effect of the channel (e.g., fading effects and/or noise effects.). The Rx node receives the output of the channel model (for each antenna at the Rx node), and/or channel information, and determines an estimate of the transmitted data (e.g., the LLRs). Based on the estimate of the transmitted data, the Rx node computes a loss function. For example, the Rx node may generate a loss function that ensures z (n), which is a combination of the sequences generated for each layer zₗ(n), is representative of the LLRs of b(n), where σ(⋅) is a sigmoid function:

$${loss}_{1} = - \frac{1}{B} {\sum }_{samples} {\sum }_{n} b ( n ) \cdot log ( σ ( z ( n ) ) + ( 1 - b ( n ) ) \cdot log ( 1 - σ ( z ( n ) ) )$$

In some cases, the loss function may ensure the output of the transmitter is power limited, else the Tx node, during the training mode, may increase its output power to compensate for any noise or distortion. For example, adding a term to the loss function to penalizing the average output power if it exceeds a certain limit may ensure the power limitation, as follows. Assuming an average power constraint on j complex symbols that are generated to be transmitted on a physical resource grid denoted by κⱼ, the corresponding loss function can be expressed as follows:

$${loss}_{2} = max ( 0 , \frac{1}{𝔧} {\sum }_{𝔧} {‖ {κ}_{j} ‖}^{2} - 1 )$$

The output of the loss function increases as the average power of κⱼ gets larger than 1 (or any other desired value), where the number of samples j is large enough to represent the average power.

The Rx node may then optimize the parameters of the model to minimize the total loss function. Thus, the Rx node (or the Tx node) may train the NN block or model (e.g., the NN-based symbol generator) using a loss function based on an accuracy of recovering the set of input bits at the receiving node and a penalty for a transmission power associated with transmitting a mapped sequence of transmission symbols on allocated REs being above a threshold transmission power (e.g., the average power constraint).

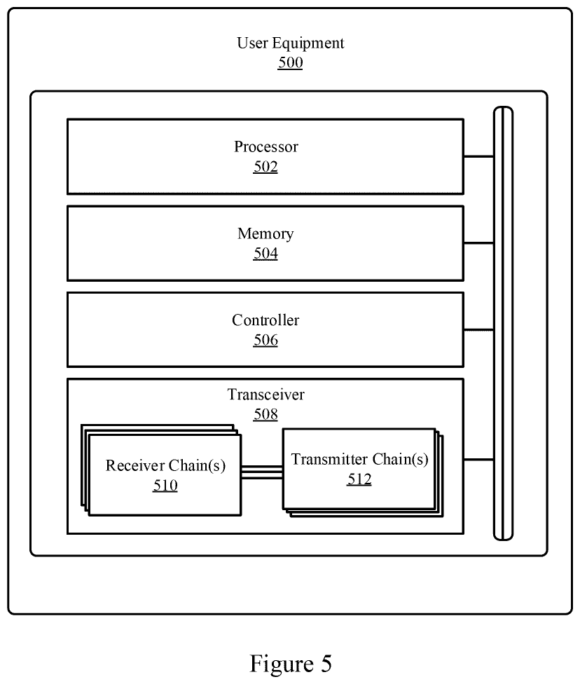

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 (e.g., as a Tx node) may be configured to support a means for receiving a set of input bits, generating a first sequence of modulation symbols based on the set of input bits, generating a second sequence of output symbols by processing a portion of the first sequence of modulation symbols with an NN-based symbol generator, generating a third sequence of transmission symbols from the second sequence of output symbols, wherein a number of transmission symbols equals a number of allocated REs for the network node, mapping the third sequence of transmission symbols to the allocated REs in a time-frequency grid, and transmitting the mapped third sequence of transmission symbols on the allocated REs to a receiving node.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

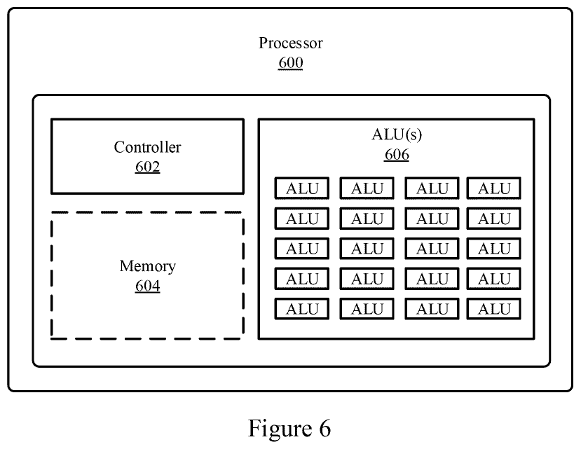

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for receiving a set of input bits, generating a first sequence of modulation symbols based on the set of input bits, generating a second sequence of output symbols by processing a portion of the first sequence of modulation symbols with an NN-based symbol generator, generating a third sequence of transmission symbols from the second sequence of output symbols, wherein a number of transmission symbols equals a number of allocated REs for the network node, mapping the third sequence of transmission symbols to the allocated REs in a time-frequency grid, and transmitting the mapped third sequence of transmission symbols on the allocated REs to a receiving node.

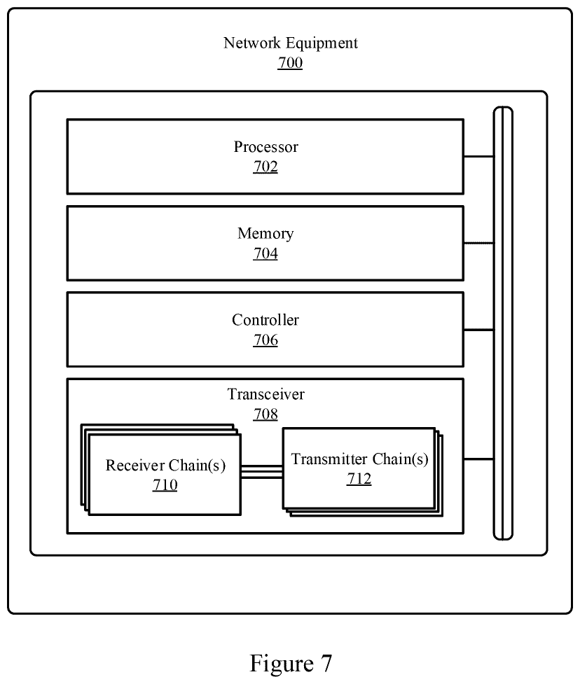

FIG. 7 illustrates an example of a NE 700 in accordance with aspects of the present disclosure. The NE 700 may include a processor 702, a memory 704, a controller 806, and a transceiver 708. The processor 702, the memory 704, the controller 806, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 806, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 (e.g., as an Rx node) may be configured to support a means for receiving multiple symbols transmitted on REs from a transmitting node, generating an estimate of a set of input bits by processing the received multiple symbols using an NN-based bit generator, and recovering the set of input bits based on the estimate of the set of input bits.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

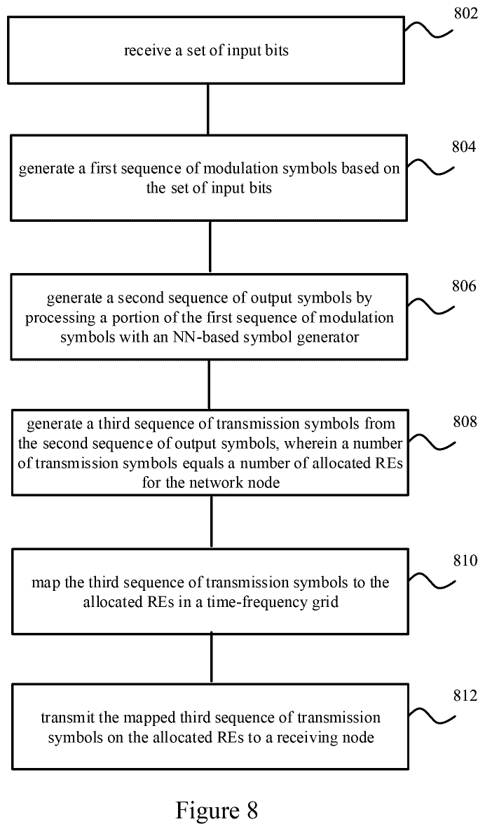

FIG. 8 illustrates a flowchart of a method in accordance with aspects of the present disclosure. The operations of the method may be implemented by a UE (e.g., as a Tx node) as described herein. In some implementations, the UE may execute a set of instructions to control the function elements of the UE to perform the described functions.

At 802, the method may include receiving a set of input bits. The operations of 802 may be performed in accordance with examples as described herein. In some implementations, aspects of the operations of 802 may be performed by a UE as described with reference to FIG. 5.

At 804, the method may include generating a first sequence of modulation symbols based on the set of input bits. The operations of 804 may be performed in accordance with examples as described herein. In some implementations, aspects of the operations of 804 may be performed a UE as described with reference to FIG. 5.

At 806, the method may include generating a second sequence of output symbols by processing a portion of the first sequence of modulation symbols with an NN-based symbol generator. The operations of 806 may be performed in accordance with examples as described herein. In some implementations, aspects of the operations of 806 may be performed a UE as described with reference to FIG. 5.

At 808, the method may include generating a third sequence of transmission symbols from the second sequence of output symbols, wherein a number of transmission symbols equals a number of allocated REs for the network node. The operations of 808 may be performed in accordance with examples as described herein. In some implementations, aspects of the operations of 808 may be performed a UE as described with reference to FIG. 5.

At 810, the method may include mapping the third sequence of transmission symbols to the allocated REs in a time-frequency grid. The operations of 810 may be performed in accordance with examples as described herein. In some implementations, aspects of the operations of 810 may be performed a UE as described with reference to FIG. 5.

At 812, the method may include transmitting the mapped third sequence of transmission symbols on the allocated REs to a receiving node. The operations of 812 may be performed in accordance with examples as described herein. In some implementations, aspects of the operations of 812 may be performed a UE as described with reference to FIG. 5.

It should be noted that the method described herein describes a possible implementation, and that the operations and the steps may be rearranged or otherwise modified and that other implementations are possible.

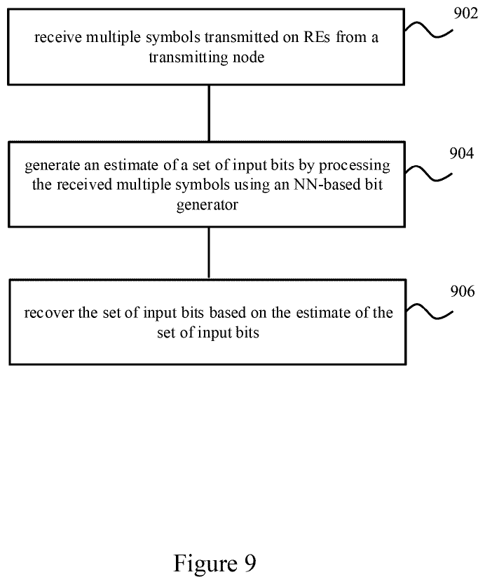

FIG. 9 illustrates a flowchart of a method in accordance with aspects of the present disclosure. The operations of the method may be implemented by an NE as described herein. In some implementations, the NE (e.g., as an Rx node) may execute a set of instructions to control the function elements of the NE to perform the described functions.

At 902, the method may include receiving multiple symbols transmitted on REs from a transmitting node. The operations of 902 may be performed in accordance with examples as described herein. In some implementations, aspects of the operations of 902 may be performed by an NE as described with reference to FIG. 7.

At 904, the method may include generating an estimate of a set of input bits by processing the received multiple symbols using an NN-based bit generator. The operations of 904 may be performed in accordance with examples as described herein. In some implementations, aspects of the operations of 904 may be performed by an NE as described with reference to FIG. 7.

At 906, the method may include recovering the set of input bits based on the estimate of the set of input bits. The operations of 906 may be performed in accordance with examples as described herein. In some implementations, aspects of the operations of 906 may be performed by an NE as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network node for wireless communication, comprising:
at least one memory; and
at least one processor coupled with the at least one memory and configured to cause the network node to:
receive a set of input bits;
generate a first sequence of modulation symbols based on the set of input bits;
generate a second sequence of output symbols by processing a portion of the first sequence of modulation symbols with a neural network (NN)-based symbol generator;
generate a third sequence of transmission symbols from the second sequence of output symbols,
wherein a number of transmission symbols equals a number of allocated resource elements (REs) for the network node;
map the third sequence of transmission symbols to the allocated REs in a time-frequency grid; and
transmit the mapped third sequence of transmission symbols on the allocated REs to a receiving node.

2. The network node of claim 1, wherein at least one symbol of the second sequence of output symbols is based on at least two bits of the set of input bits that are modulated in distinct symbols of the first sequence of modulation symbols.

3. The network node of claim 1, wherein a part of the third sequence of transmission symbols is further based on modulation symbols of the first sequence of modulation symbols not processed by the NN-based symbol generator.

4. The network node of claim 1, wherein the at least one processor is configured to cause the network node to nullify or insert reference signals or other symbols at predetermined RE positions from the allocated REs when mapping the third sequence of transmission symbols to the allocated REs in the time-frequency grid, and wherein the number of transmission symbols equals the number of allocated REs minus a number of the REs that are nullified or filled with reference signals or other symbols.

5. The network node of claim 1, wherein one or more input bits of the set of input bits are associated with two or more distinct output symbols of the second sequence of output symbols.

6. The network node of claim 1, wherein a number of modulation symbols of the first sequence of modulation symbols is less than the number of allocated REs for the network node.

7. The network node of claim 1, wherein the at least one processor is configured to cause the network node to generate the second sequence of output symbols by inputting additional inputs associated with transmission conditions or parameters to the NN-based symbol generator.

8. The network node of claim 7, wherein the additional inputs include a channel quality indicator, a signal-to-noise value, a precoding matrix identifier, a rank indicator, or an environment type classification.

9. The network node of claim 1, wherein the second sequence of output symbols includes at least output symbols that is not based on the set of input bits.

10. The network node of claim 1, wherein a number of output symbols of the second sequence of output symbols is less than the number of allocated REs for the network node, and wherein the at least one processor is configured to cause the network node to generate the third sequence of transmission symbols by combining output symbols with one or more modulation symbols to fill all of the allocated REs.

11. The network node of claim 1, wherein the at least one processor is further configured to cause the network node to train the NN-based symbol generator using a loss function based on:
an accuracy of recovering the set of input bits at the receiving node; and
a penalty for a transmission power associated with transmitting the mapped third sequence of transmission symbols on the allocated REs being above a threshold transmission power.

12. The network node of claim 1, wherein the NN-based symbol generator includes multiple NN blocks associated with multiple spatial layers via which the network node transmits the mapped third sequence of transmission symbols, and wherein each NN block processes modulation symbols for a respective spatial layer of the multiple spatial layers.

13. The network node of claim 1, wherein the at least one processor is configured to cause the network node to generate the third sequence of transmission symbols from the second sequence of output symbols by embedding reference information into the third sequence with data-carrying symbols.

14. A network node for wireless communication, comprising:
at least one memory; and
at least one processor coupled with the at least one memory and configured to cause the network node to:
receive multiple symbols transmitted on resource elements (REs) from a transmitting node;
generate an estimate of a set of input bits by processing the received multiple symbols using a neural network (NN)-based bit generator; and
recover the set of input bits based on the estimate of the set of input bits.

15. The network node of claim 14, wherein the at least one processor is configured to cause the network node to generate the estimate of the set of input bits by inputting additional inputs associated with reception conditions to the NN-based bit generator.

16. The network node of claim 15, wherein the addition inputs include an indication of RE positions associated with reference symbols or non-data symbols, channel state information or estimated channel values for the REs, or a channel quality metric associated with the reception conditions.

17. The network node of claim 14, wherein the estimate of the set of input bits includes a soft decision value or a log-likelihood ratio, and wherein the at least one processor is configured to cause the network node to recover the set of input bits by inputting the soft decision value or the log-likelihood ratio into a forward error correction decoder to reconstruct the set of input bits.

18. The network node of claim 14, wherein the NN-based bit generator includes:
a single NN model configured to jointly process symbols received from multiple spatial layers; or
multiple NN models each configured to process symbols received from a single spatial layer of the multiple spatial layers.

19. A method performed by a network node, the method comprising:
receiving a set of input bits;
generating a first sequence of modulation symbols based on the set of input bits;
generating a second sequence of output symbols by processing a portion of the first sequence of modulation symbols with a neural network (NN)-based symbol generator;
generating a third sequence of transmission symbols from the second sequence of output symbols,
wherein a number of transmission symbols equals a number of allocated resource elements (REs) for the network node;
mapping the third sequence of transmission symbols to the allocated REs in a time-frequency grid; and
transmitting the mapped third sequence of transmission symbols on the allocated REs to a receiving node.

20. A method performed by a network node, the method comprising:
receiving multiple symbols transmitted on resource elements (REs) from a transmitting node;
generating an estimate of a set of input bits by processing the received multiple symbols using a neural network (NN)-based bit generator; and
recovering the set of input bits based on the estimate of the set of input bits.
